(19) United States
(12) Patent Application Publication
(10) Pub. No.: US 2010/0322036 A1
(43) Pub. Date: Dec. 23, 2010

(54) TIMEPIECE HAND, MOVEMENT FOR DRIVING SUCH A HAND AND CORRESPONDING TIMEPIECE

(75) Inventors: Frederic Crettex, Prangins (CH); Sebastien Jeanneret, Le Locle (CH)

Correspondence Address: YOUNG & THOMPSON, 209 Madison Street, Suite 500, Alexandria, VA, 22314, US

(73) Assignee: VAUCHER MANUFACTURE FLEURIER S.A., Fleurier (CH)

(21) Appl. No.: 12/446,406

(22) PCT Filed: Oct. 19, 2007
(86) PCT No.: PCT/EP2007/061227

§ 371 Date: Apr. 20, 2009

(30) Foreign Application Priority Data
Oct. 20, 2006 (EP) 06122680.9

(51) Int. Cl. G04B 19/04

(52) U.S. Cl. 368/80

(57) ABSTRACT

A hand for a timepiece including a base is intended to be driven by a drive member of a clock movement to rotate about a first axis of rotation, the base being extended by a first index portion. The latter defines a support for a second index portion intended to be driven in terms of rotation with respect to the support about a second axis of rotation substantially perpendicular to the first axis of rotation by a drive mobile of the clock movement. The hand can be driven conventionally to display the time, in relation to graduations borne by a dial, while rotation of the second index portion allows additional information to be displayed which may be independent of the time. The resulting bulk of this structure is modest and visually de-clutters the display area of the timepiece while allowing several timekeeping complications to be displayed simultaneously.

### TECHNICAL FIELD

The present invention relates to a hand for a timepiece comprising a base, intended to be driven by a drive member of a clock movement to rotate about a first axis of rotation, the base being extended by a first index portion intended to collaborate with graduations of the timepiece.

The present invention also relates to a clock movement designed to allow such a hand to be driven and to a timepiece comprising this movement associated with this hand.

### PRIOR ART

Such hands are commonplace in the field of horology, a timepiece generally having several of these, each associated with a predefined particular parameter, in relation to graduations borne by a dial.

Thus, timepieces have long been known in which three hands are used to display the hours, minutes and seconds, while additional hands are provided to display supplementary information such as the date, a second time zone, the phases of the moon, the power reserve, etc.

Because of concerns associated with bulk, particularly the display area of the timepiece, it may, however, be desirable to associate a hand with several parameters to be displayed simultaneously, particularly in the case of timepieces in the complication style.

By way of example, patent application EP 1 413 934, published on Apr. 28, 2004 in the name of ETA SA a Swiss clockmaker, describes a timepiece in which an hours hand that makes one revolution in twelve hours is mounted coaxially on a disk driven by the movement in order to make one revolution in twenty-four hours. The disk is made up of two half-disks, one light and the other dark, which are positioned with reference to the hours hand in order to indicate day or night in relation to this hand. By virtue of this structure, the hours hand displays two items of time information simultaneously.

Furthermore, U.S. Pat. No. 4,583,864 describes a watch representing the solar system. This watch comprises a mechanism designed in such a way that, when the shaft of the seconds hand rotates under the action of the movement, the earth moves in a circular orbit and also revolves about its axis.

Finally, European application EP 1 705 535 describes a timepiece comprising a sun gear rotating about a first axis of rotation and comprising three pivot shafts on which planet gears are pivot-mounted. The planet gears revolve about a second axis of rotation perpendicular to the first axis. The mechanism is arranged in such a way that the rotation of the planet gears is associated with the rotation of the sun gear.

However, the mechanisms described in the aforementioned patents or patent applications are unable simultaneously to indicate parameters that are independent of one another.

### DISCLOSURE OF THE INVENTION

A main object of the present invention is to alleviate the disadvantages of the known mechanisms of the prior art by proposing a hand for a timepiece that allows a number of information items to be displayed simultaneously, some of these information items being independent of one another, and a movement able to control such a hand.

To this end, the present information more particularly relates to a hand of the type mentioned above, characterized in that the first index portion defines a support for a second index portion equipped with a spur or bevel toothing, with reference to a second axis of rotation substantially perpendicular to the first axis of rotation, and intended to be driven in terms of rotation with respect to the support, about the second axis of rotation, by a drive mobile of the clock movement.

By virtue of this feature, the hand may be driven in the conventional way in order to display the time, for example, in relation to graduations borne by a dial, while rotation of the second index portion allows an additional piece of information to be displayed which may be independent of the time. Furthermore, the resulting bulk of this structure is modest and allows the display region of the corresponding timepiece to be visually de-cluttered by comparison with the solutions of the prior art.

Numerous alternative forms of embodiment are conceivable without departing from the scope of the invention, depending on the parameter chosen. In particular, it is possible to anticipate driving the second index portion continuously, in order to display a power reserve, for example, or to drive it periodically, in order to display day/night information or alternatively the activation condition of an additional function, such as an alarm, for example. In such cases, the second index portion has graduations relating to the value of a parameter associated with said clock movement or relating to a time parameter.

According to an alternative form of embodiment, provision may be made for the hand to comprise a third index portion also mounted to rotate with reference to the support and driven off the movement in order to display an additional parameter. As a preference, the third index portion is coaxial with said first and second portions and arranged between these, this portion being intended to be driven in terms of rotation with respect to said support by said clock movement about said second axis of rotation and independently of said second index portion.

By virtue of these features it is possible, by way of illustration, to anticipate displaying the power reserve of a clock movement and the day/night information using the hours hand alone.

The invention also relates to a clock movement comprising a going train kinematically connected to drive means for rotationally driving at least a base of a hand about a first axis of rotation substantially perpendicular to an overall plane of the movement, said base being secured to a first index portion intended to collaborate with graduations of the timepiece, and characterized in that it further comprises at least one additional drive mobile designed to drive a second index portion of said hand, this second portion being supported by said first index portion, in terms of rotation about a second axis of rotation substantially perpendicular to said first axis of rotation.

The invention also relates to a timepiece comprising a case closed by a glass and defining a housing in which there is positioned a clock movement as defined herein above, said movement being designed to drive a hand as defined hereinabove, this hand moving between said movement and said glass.

### BRIEF DESCRIPTION OF THE DRAWINGS

Other features and advantages of the present invention will become more clearly apparent from reading the detailed description of a preferred embodiment which follows, given with reference to the attached drawings which are provided by way of nonlimiting examples and in which:

FIG. 1 depicts a simplified plan view, from the bridges side, of one exemplary embodiment of a movement for a timepiece according to a preferred embodiment of the present invention;

FIG. 2 depicts a simplified cross-sectional view of part of the movement of FIG. 1, the section being on II-II;

FIG. 3 depicts a simplified cross-sectional view of another part of the movement of FIG. 1, the section being on III-III visible in FIG. 5;

FIG. 4 depicts a simplified plan view, from the plate side, of part of the movement for the timepiece of FIG. 1;

FIG. 5 depicts a simplified plan view similar to the view of FIG. 4 of another part of the movement for the timepiece of FIG. 1 in a first configuration;

FIG. 6 depicts a simplified plan view similar to the view of FIG. 5, in a second configuration;

FIG. 7a depicts a simplified cross-sectional view of a constructional detail of the movement of FIG. 1, according to an alternative form of embodiment; and

FIG. 7b depicts a simplified cross-sectional view of the constructional detail of FIG. 7a, on the plane of section identified by the line P-P in FIG. 7a, perpendicular to the plane of the latter.

### EMBODIMENT(S) OF THE INVENTION

The figures and the detailed description which follow relate to a movement for a timepiece comprising a mechanism for indicating the power reserve, by way of nonlimiting illustration. In particular, the mechanism for indicating the power reserve is of the type comprising differential gearing similar to the mechanism described in European patent application EP 1 139 182 A1 in the name of the Applicant Company, and its workings will not be described in detail insofar as the subject matter of the present invention does not relate directly to this mechanism. The part of the description of the aforementioned application relating to how the differential works is incorporated into this application by reference.

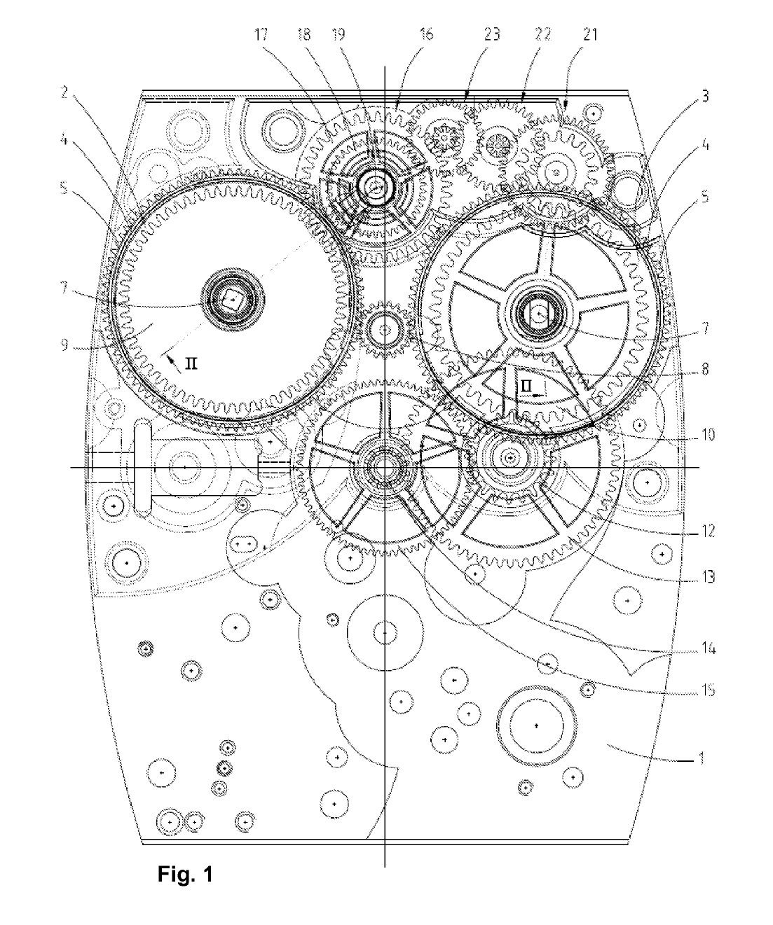

FIG. 1 depicts this timepiece movement in a simplified plan view from the bridges side.

The movement comprises a plate 1 which has various holes and countersinks designed for locating and positioning most of the components of the movement, in the conventional way.

The plate in particular bears two barrels 2 and 3 forming the drive member or source of energy of the clock movement. These two barrels 2 and 3 each comprise a drum 4 having a spur toothing 5 and closed by a cover 6. A main-spring (not visible) is typically housed in each of the drums, connected to a barrel shaft 7, by an internal first end, and to the drum, by an external second end. Each of the shafts 7 allows the corresponding barrel to be mounted for rotation with reference to the plate.

The two barrels 2 and 3 are mounted in series, the toothings 5 of their respective drums being positioned in mesh with one another through a pinion 8.

The barrels are loaded by action of the user on a conventional winding mechanism (not depicted) acting, on the input side of the drive member, on a ratchet 9 which rotates as one with the shaft 7 of a first barrel 2, rotating the internal end of the corresponding spring. The spring in the second barrel 3 is wound via the drum of the first barrel, the pinion 8 and the drum of the second barrel. The output from the drive member to the going train (not fully depicted) of the movement is in the form of a wheel 10 which rotates as one with the shaft 7 of the second barrel 3.

The wheel 10 is arranged in mesh with the pinion 12 of a center wheel mobile the wheel 13 of which is in mesh with a center pinion 14. In a known way, the center pinion rotates as one with a center wheel 15 which has a kinematic connection with a mechanical oscillator, not depicted, that provides a time base to regulate the running of display components of the timepiece.

Furthermore, the movement comprises a mechanism able to control a display of the power reserve of the barrels 2 and 3. This mechanism comprises a differential gearing 16 with a first wheel 17 defining a first input of the differential, a second wheel 18 defining a second input of the differential, and a central shaft 19 defining an output thereof.

The first wheel 17 is arranged directly in mesh with the ratchet 9 of the first barrel 2, while the second wheel 18 is kinematically connected to the output wheel 10 of the drive member via a multiplying gear-train comprising, by way of a nonlimiting illustration, first, second and third mobiles 21, 22 and 23.

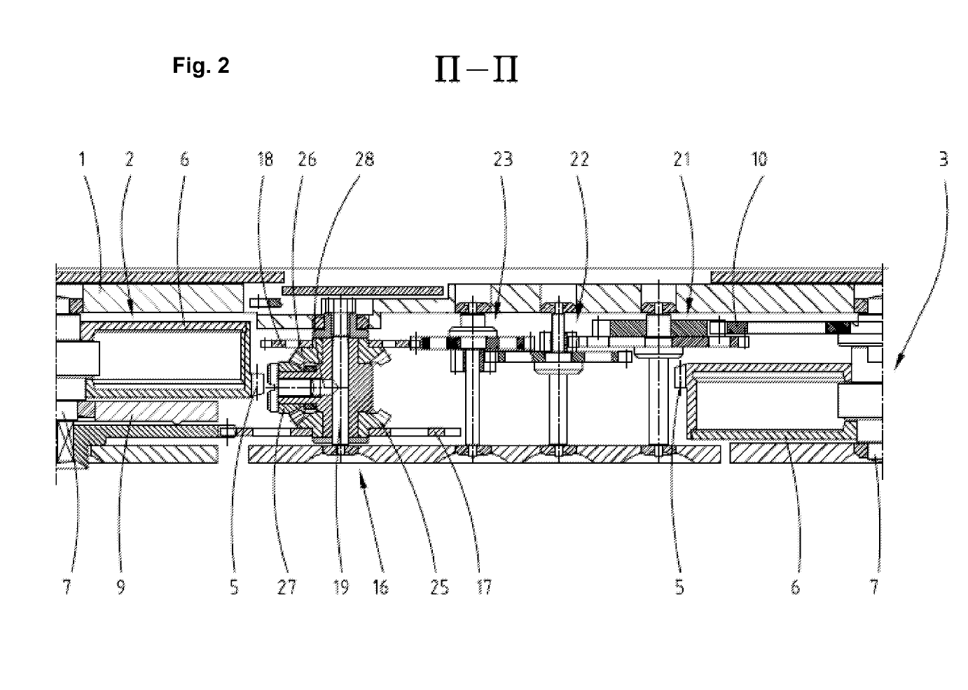

FIG. 2, which depicts a simplified view in cross section on II-II of FIG. 1 clarifies the way in which the mechanism that indicates the power reserve works.

Each of the input wheels 17 and 18 of the differential is secured to a toothing 25, 26 positioned in mesh with the toothing of a planetary wheel 27 secured to the central shaft 19 and free to revolve about an axis of rotation 28 perpendicular to this shaft.

Thus, during winding operations, rotation of the ratchet 9 brings about rotation of the first input wheel 17 which turns the central shaft 19 via the planetary wheel 27, it being possible for the second input wheel 18 to be considered to be substantially fixed for the duration of the winding.

When the movement is operating normally, the source of energy discharges, supplying the oscillator with energy, this oscillator being released from the output wheel 10 of the second barrel 3, while the ratchet 9 of the first barrel 2 remains immobile. The slow rotation of the wheel 10 is transmitted to the second input wheel 18 of the differential via the multiplying gear-train 21, 22, 23 and thus to the central shaft 19, via the planetary wheel 27.

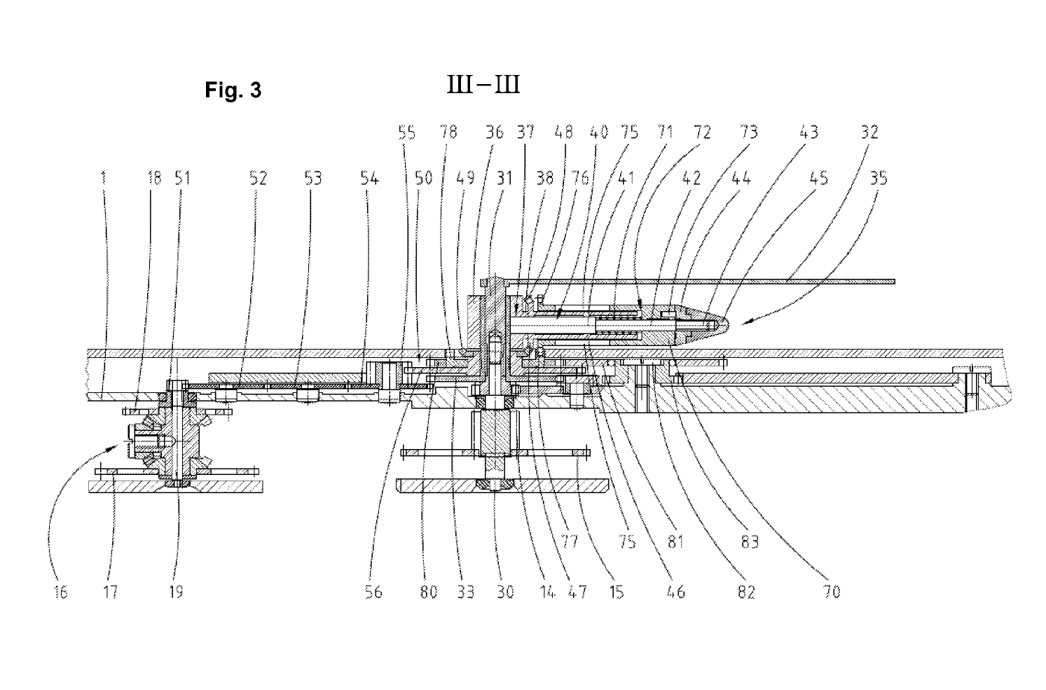

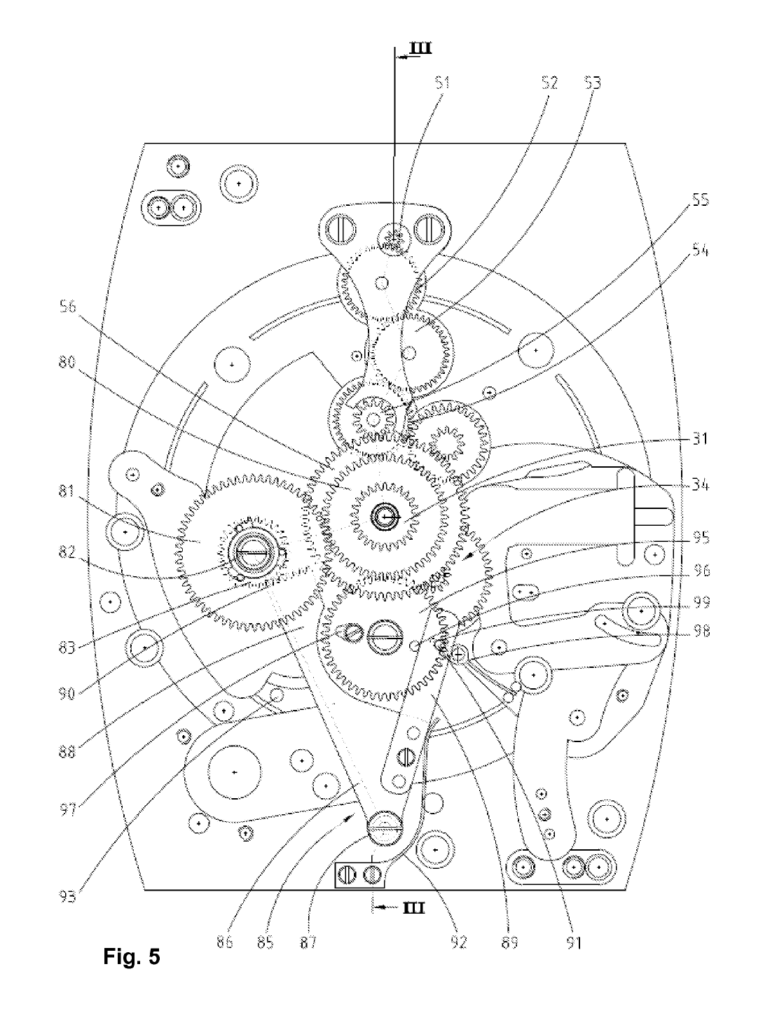

FIG. 3, which depicts a simplified cross-sectional view of another part of the movement, the section being taken on III-III of FIG. 5, illustrates the transmission of movements from the central shaft 19 of the differential to a display member and the way in which the information relating to the power reserve can advantageously be displayed by this display member according to the invention.

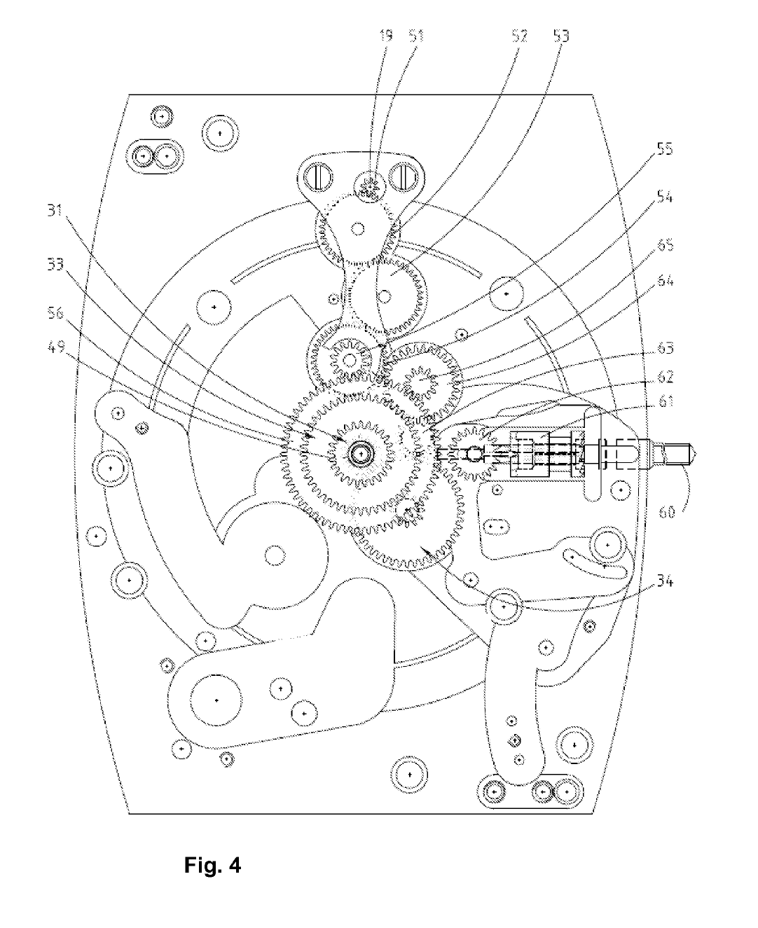

The shaft 30 of the center wheel bears a cannon-pinion 31, in the conventional way, onto which a minute hand 32 is driven. Furthermore, the cannon-pinion 31 is connected to an hours wheel 33 by a motion-work (referenced 34 in FIG. 4).

The hours wheel 33, typically driven by the center wheel so that it makes one revolution upon itself in twelve hours, bears an hours hand 35 driven onto its pipe.

The hours hand 35 comprises a base 36 of cylindrical overall shape, its axis being coincident with the axis of rotation of the hours wheel, and having a central hole via which it is driven onto the pipe of the hours wheel 33.

The base 36 comprises an additional through-hole 37 directed perpendicular to the axis of rotation of the hours wheel. An annular bulge 38 is created around the hole 37 to form an additional thickness of material at this point.

The base 36 comprises a pipe the axis of which is coincident with said first axis of rotation, said first index portion being defined by a shaft 40 running substantially perpendicular to said pipe from said base 36. For that, the shaft 40 is driven into the hole 37, this hole having, in its length from the base 36 of the hand, three cylindrical sections 41, 42 and 43 each of which has a diameter slightly smaller than that of the previous section. The third section 43 has a screw thread, by way of illustration, onto which two adjacent end portions 44, 45 of conical overall shape are screwed to define the end of the hours hand 35. As will be seen later on, the end portion 44 may constitute a retaining element 44, some distance from the base 36, defining an axial banking for a second index portion.

A pipe 46 defining a second index portion of the hours hand is rotationally mounted on the first section 41 of the shaft 40, being positioned in abutment against the annular bulge 38 of the base via its first end 47.

The first end 47 is equipped with a radial extension bearing a bevel toothing 48, the latter being positioned in mesh with the bevel toothing 49 of an additional drive mobile 50 mounted to rotate freely on the hours wheel 33.

The additional drive mobile 50 is made to associate the angular position of said second index portion 46 with the magnitude of said power reserve at each moment.

The drive mobile 50 is kinematically connected to the output of the differential gearing 16. To this end, there is a reducer-gear comprising, starting from the shaft 19 of the differential, bearing a pinion 51, first and second setting wheels 52 and 53 followed by a mobile the wheel 54 of which is in mesh with the second setting wheel 53 and the pinion 55 of which is in mesh with a wheel 56 of the drive mobile 50. The wheel 56 and the bevel toothing 49 of the drive mobile 50 are secured to one another in such a way that the information relating to the power reserve of the source of energy, which information is generated from the differential 16, is transmitted to the pipe 46 of the hours hand 35.

By virtue of this mechanism, the pipe 46 is driven in rotation with respect to the base 36 of the hours hand, about the shaft 40, as a function of the change in the magnitude of the power reserve of the source of energy of the clock movement. In order to exploit this particular feature, there are various ways of displaying the corresponding magnitude of the power reserve that may be adopted. In particular, provision may be made for the pipe 46 to have graduations, in days or in hours, of which the magnitude displayed toward the plane in which the minutes hand moves corresponds to the actual magnitude of the power reserve. Provision may also be made for the first index portion of the hours hand to bear a fixed mark, designed to lie facing the relevant magnitude, borne by the pipe, at each moment. In an alternative form of embodiment, it is conceivable to have graduations in a helix extending in the axial direction of the pipe 46, allowing an improvement in the legibility thereof.

It will be noted that when the hours wheel 33 is rotationally driven, the hours hand 35 does the same which, for a constant power reserve, namely when the drive mobile 50 is fixed, causes the pipe 46 to turn about the first index portion of the hours hand. What actually happens in this case is that the bevel tooth set 48 of the pipe runs along the fixed toothing 49 of the drive mobile. Thus, if no special steps are taken to take this phenomenon into consideration, then the latter may give rise to a drift of the indication of the power reserve with reference to its actual magnitude.

In the context of the preferred embodiment of the invention described here, such a drift is neutralized by choosing an appropriate set of gear ratios for the multiplying gear-train 21, 22, 23 positioned between the output 10 of the source of energy and the second input 18 of the differential gearing 16. It will be noted that this choice depends in particular on the number of desired revolutions of the pipe 46 between the graduations corresponding to the minimum and maximum magnitudes of the power reserve, and to the number of revolutions that the shaft 7 of the second barrel 3 makes between these same magnitudes. A person skilled in the art will be able to adapt the various gear-trains involved to suit his own requirements without departing from the scope of the present invention.

Furthermore, it will also be noted that the clock movement comprises a conventional setting mechanism depicted schematically in FIG. 4 which depicts a simplified plan view, from the plate side, of some of the elements that have just been described in conjunction with FIG. 3.

The setting mechanism comprises a setting stem 60 bearing a sliding pinion 61 intended to be brought into mesh with a setting wheel 62, here mounted for translational movement with respect to the plate 1 so as to engage with the wheel of the motion-work 34 only in the setting position.

In order to avoid corrupting the indication of the magnitude of the power reserve when moving the hours wheel 33 from the motion-work during a setting operation, a compensation gear-train may be provided. This compensation gear-train comprises a setting wheel 63 positioned in mesh with the wheel of the motion-work 34 and meshing with a wheel 64 of a compensation mobile the pinion 65 of which is in mesh with the wheel 56 of the drive mobile 50. Thanks to this structure, when the hours wheel 33 is rotationally driven off the setting mechanism, the drive mobile 50 is at the same time rotationally driven in one direction and to an extent that allows the angular position of the pipe 46 to be kept fixed relative to the base 36 of the hours hand 35.

Indenting is preferably provided, in this case, between the pinion 55 and the wheel 54, to neutralize the compensation applied to the wheel 56 which causes the pinion 55 to rotate. In the absence of such indenting, the indication of the magnitude of the power reserve may be corrupted and the set of gears in the corresponding mechanism may possibly become damaged.

Returning to FIG. 3, a special mechanism for displaying an additional item of information, namely day/night information, using the hours hand 35, will now be described.

It can be seen from FIG. 3 that the hours hand 35 comprises a third index portion coaxial with the shaft 40 and positioned around the pipe 46 and, also having the form of a pipe 70 free to pivot with respect to the pipe 46 and with respect to the shaft 40.

The hand comprises elastic means 71 designed to exert a force on the second index portion corresponding to the pipe 70 tending to keep it against the axial banking defined by the retaining element 44 while at the same time allowing it to move away from said axial banking in order to revolve on itself. These elastic means are, for example, a helical spring 71 which is interposed between the pipe 46 and the second section 42 of the shaft 40, being preloaded between, on the one hand, the flank of the first section 41 of the shaft 40 and, on the other hand, an annular internal surface 72 of the pipe 70. The latter therefore finds itself bearing against the end portion constituting the retaining element 44 of the first index portion, this retaining element defining the axial banking for the pipe 70, under the effect of the force exerted by the spring 71.

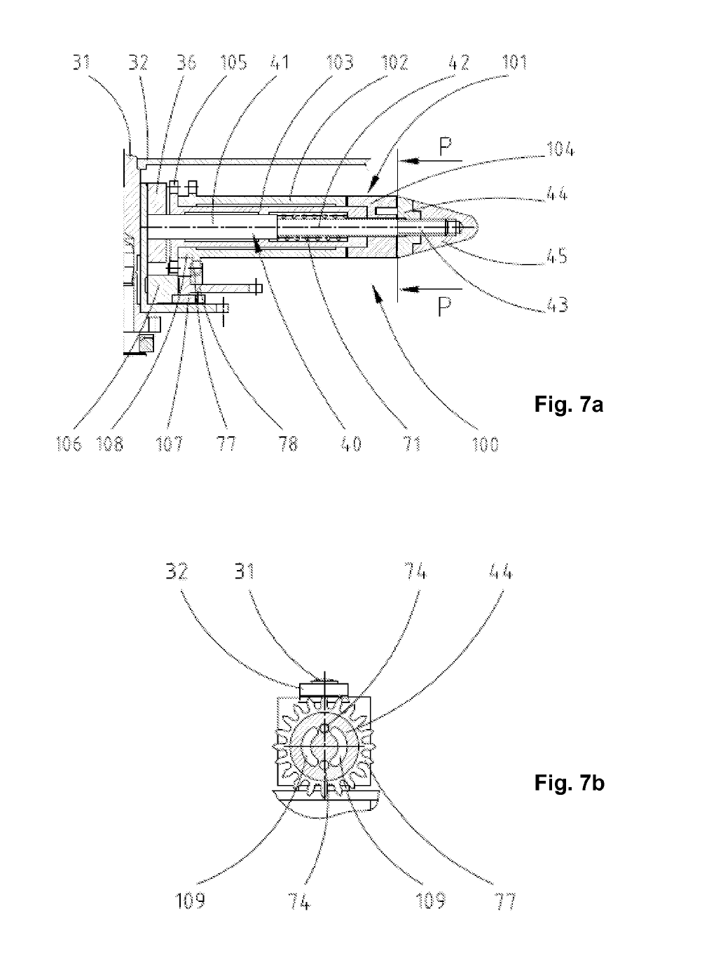

Furthermore, said axial banking also performs a function of angularly positioning the second index portion corresponding to the pipe 70 with respect to the base 36. The pipe 70 can occupy two stable angular positions in its rotational movements, these being identified by the collaboration of a pin 73 driven into the pipe with a first or a second blind hole 74 (visible in FIG. 7b) of the end portion 44. By way of indication, provision may be made for the pipe to be divided into two halves along a plane containing its axis of symmetry, each half having its own specific color designed to make it possible easily to make out the day/night information. In this case, only half is visible to a user in each of the two stable angular positions of the pipe.

Of course, it is possible to provide different angular positioning means, such as a ball ratchet, and means arranged differently, particularly separate from the axial banking of the pipe 70.

The pipe 70 has at least one moving window 75 positioned in such a way that it moves in order to reveal or conceal a visual marking representative of the angular position of the latter relative to the base 36. For example, two windows 75 are formed in the pipe 70 and associated with the two stable positions mentioned hereinabove in order to reveal the graduations borne by the pipe 46 in relation to the magnitude of the power reserve.

There is an additional drive mobile 78, 80 designed to drive a second index portion of said hand and having a spur or bevel toothing intended to mesh with a spur or bevel toothing 77 of the second index portion defined by the pipe 70. Indeed, the end 76 of the pipe 70 situated near the base 36 of the hours hand 35 has a spur or bevel toothing 77 positioned in mesh with the toothing on the edge of an annular wheel 78 mounted to pivot about the hours wheel 33. The additional drive mobile 78, 80 is arranged in such a way that it periodically drives said second index portion 70 so that it makes half a revolution on itself in order to display a first or a second of two distinct angular positions.

The annular wheel 78 is secured to an additional annular wheel 80 bearing a toothing in mesh with the wheel 81 of a roller-type disconnecting-gear of conventional type fixed to the plate 1 by means of a shouldered screw 82. The disconnecting-gear is designed to transmit the relative rotational movements of its wheel and of its pinion in just one, transmitting, direction, in the known way.

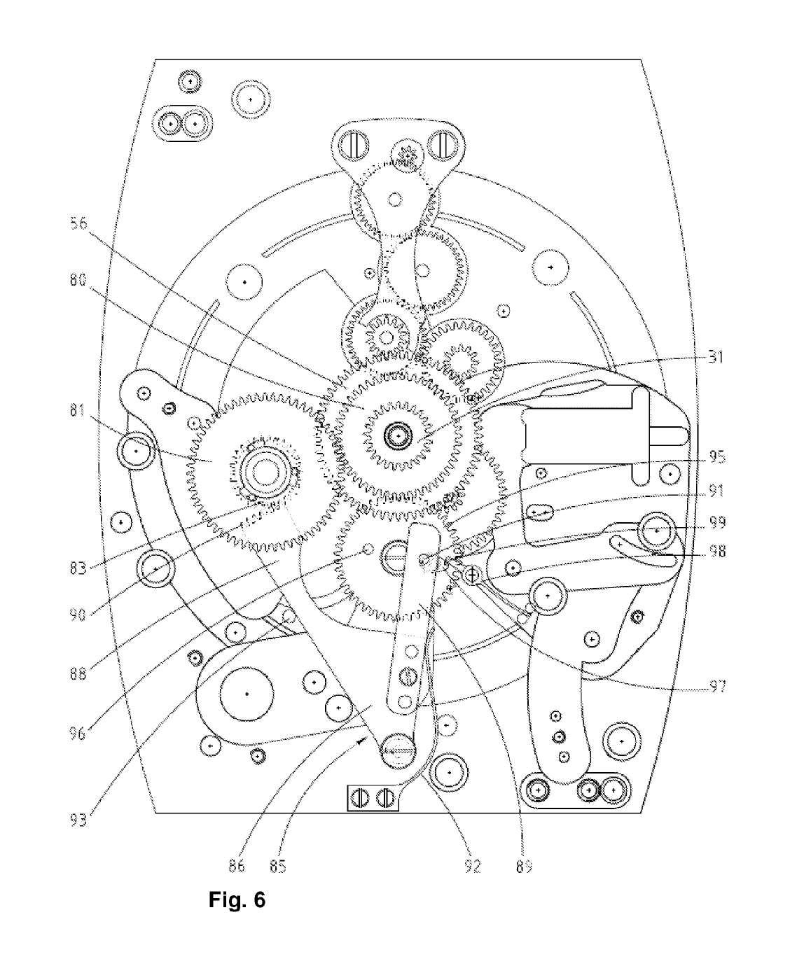

A mechanism of the whip type actuated to control the movements of said additional drive mobile 78, 80 is provided to act on the pinion 83 of the disconnecting-gear and cause it to revolve through a predefined fraction of a revolution, in the transmission direction, every twelve hours. The way in which this mechanism works will be described in greater detail in conjunction with FIGS. 5 and 6 which depict it in similar simplified plan views, in two different configurations.

The pinion 83 is rotationally driven by a lever 85 comprising a base 86 pivot-mounted on the plate by means of a shouldered screw 87 and from which two arms 88 and 89 extend, forming a predefined angle. The arm 88 bears a rack 90, at its free end, the toothing of which is designed to mesh with the toothing of the pinion 83. The arm 89 bears a locking pin 91 in the region of its free end, the function of which will be explained hereinbelow. A long return spring 92 is mounted on the plate so as to exert on the arm 89 a force that tends to push it back in the counterclockwise direction of rotation in FIGS. 5 and 6, a banking 93 secured to the plate being provided to define the corresponding rest position of the lever 85.

The whip mechanism also comprises a control wheel 95 rotationally driven in the counterclockwise direction directly by the hours wheel 33 and bearing, on the one hand, a pin 96 and, on the other hand, a pallet 97.

The angular positioning of the control wheel 95 is such that, during a winding phase that takes place outside of the times adopted for changing the day/night indication which times are generally at around six in the morning and six in the evening, the pin 96 comes into contact with the arm 89 of the lever 85 and exerts on it a force that opposes the force of the return spring 92 so as to pivot the lever in the clockwise direction.

When the whip mechanism is in the configuration depicted in FIG. 5, the locking pin 91 borne by the arm 89 collaborates with the catch of a ratchet spring 98 fixed to the plate 1 to lock the lever 85 in the wound position.

The disconnecting-gear is arranged in such a way that the rotational movement of its pinion 83, caused by the movement of the rack 90, is not transmitted to its wheel 81, which remains immobile.

The pallet 97 is positioned substantially on the same diameter of the control wheel 95 as its pin 96, by way of nonlimiting illustration. Hence, about six hours after the lever 86 has been wound, the pallet 97 comes into contact with a beak 99 situated at the end of the ratchet spring 98, to deform the latter and release the lever locking pin 91.

When the lever 85 is released, it pivots in the counterclockwise direction under the effect of the force exerted by the return spring 92, to whip the pinion 83 of the disconnecting-gear, the corresponding movement of the rack 90 causing the pinion 83 to rotate quickly in the transmitting direction which, in this instance, is in the clockwise direction.

FIG. 6 depicts the whip mechanism when the pallet has just released the lever, but is still in contact with the beak 99 of the ratchet spring 98.

It is clear from this figure that the beak 99 has an additional thickness intended to collaborate with the pin 91 of the lever, via a bearing surface, so as to lock this lever at the end of winding. The bearing surface is advantageously curved to give the lever better stability in the locked position. Furthermore, it should be noted that the thickness of the pallet 97 is less than that of the pin 96, allowing it to move past the lever without touching it, insofar as it does not need to have any direct interaction with the lever, unlike the pin.

The gear ratios between the rack 90, the pinion 83, the wheel 81, the annular wheels 80 and 78 and the spur toothing 77 of the pipe 70 are preferably chosen so that each pivoting movement of the lever 85 causes the pipe 70 to rotate through half a revolution in order to change the day/night information on the hours hand 35.

As has already been mentioned and will become more clearly apparent in the course of the description of FIG. 7b, when the pipe 70 is driven to make half a revolution, the pin 73 is extracted from one blind hole 74 in the first index portion before becoming lodged in the other. Extraction of the pin 73 becomes possible as a result of the compression of the helical spring 71.

It may be noted that, by virtue of the structure just described, the change in day/night information takes place also during setting operations, whether these are performed by moving the hands in the clockwise direction or in the counterclockwise direction.

During the every-day operation of the hours hand 35, the pipe 70 is immobilized by collaboration of the pin 73 with one of the blind holes 74. As a result, the annular wheels 78 and 80 are rotationally driven and rotate the wheel 81 of the disconnecting-gear in the non-transmitting direction of rotation, the rotation therefore not being transmitted to the pinion 83. By virtue of this structure, any deviation liable to creep into the power reserve is neutralized directly by the disconnecting-gear.

Of course, the possible applications of the principle that has just been described are practically unlimited inasmuch as all kinds of information can be displayed instead of the day/night information, for example in particular a second time zone, seconds, the day of the week, the date, the week, the month, leap years, etc.

By way of nonlimiting example, the distribution of the display surface available between the pipes 46 and 70 can be altered and provision may be made to display a date on the pipe 70, the corresponding information being distributed in a helix, as has already been suggested in relation to the power reserve.

Provision may also be made for the pipe 70 to be rotated continuously, by replacing the lever 85 by a setting wheel driven directly by the control wheel 96 and in mesh with the pinion 83 of the disconnecting-gear.

Alternatively, it is possible to arrange an external control member on the corresponding timepiece, coupled to a mechanism which would allow the pipe 70 to be turned manually. A mechanism such as this could be formed on the basis of a preexisting complication in the movement, such as an alarm function or a striking works mechanism, or alternatively a switch between two time zones, the pipe 70 then being put to use to indicate the operational status of the complication, switched on or off in the case of the alarm or striking mechanism.

Furthermore, the structure described for the hours hand 35 is nonlimiting. FIG. 7a depicts a view in cross section of an hours hand 100 according to an alternative form of embodiment, by way of illustration. The elements already described in conjunction with the preceding figures bear the same numerical references as before in order to make this alternative form of embodiment easier to understand.

The hours hand 100 comprises a base 36 from which there extends a shaft 40 bearing two end portions 44 and 45 just as explained above.

Furthermore, the first index portion comprising the shaft and the end portions defines a support for first and second pipes 101 and 102, having the same respective axes as the shaft 40. The pipe 102 defines a third index portion.

The first pipe 101 is mounted to rotate freely on the first section 41 of the shaft 40 via its main portion 103, this being secured to an end portion 104 comprising a pin 73 intended to collaborate with two blind holes 74 belonging to the end portion 44. A helical spring 71 is prestressed between the pipe 101 and the flank of the first section 41 in order to keep the pipe pressed against the end portion 44.

Advantageously, when the pipe 101 is used to display the day/night information, provision may be made for it to be split into two halves along a plane containing its axis of symmetry, just one half being visible to a user at a time, in order to distinguish the day/night information.

More specifically, the end portion 104 of the pipe 101 has transverse dimensions identical to those of the end portion 44, where these two elements meet, so as to ensure continuity in the shape of the hours hand 100 and is intended to show the division for displaying the day/night information.

The base 36 end of the pipe 101 has a spur toothing 105 in mesh with the toothing of a mobile 106 mounted to rotate freely about the hours wheel 33 and driven by an annular wheel 107 to which it is secured. A person skilled in the art will have no particular difficulty in implementing means for driving the annular wheel 107 that are suited to his own requirements on the basis of the foregoing teaching.

The second pipe 102 is rotationally mounted on the main portion 103 of the first pipe 101, its exterior wall lying substantially in the continuation of that of the end portion 104 thereof.

Advantageously, the end 108 of the second pipe, situated at the same end as the base 36 of the hand, comprises a spur toothing 77 or bevel toothing, in mesh with the toothing of a driving mobile 78 rotationally mounted on the mobile 106 and the annular wheel 107. Just as was described previously, the drive mobile 78 may be made to display the magnitude of the power reserve of the source of energy of the movement by suitable rotation of the pipe 102 about the shaft 40.

The current alternative form of embodiment thus proposes a structure of the fold-out type, by virtue of which there is no need to provide one or more windows on the outermost pipe in order to allow information borne on the innermost pipe to be viewed.

FIG. 7b depicts the construction of the hours hand in detail, on the plane of section marked P-P in FIG. 7a, that is to say a plane of section passing near the side wall of the end portion 44.

This figure shows the appearance of the blind holes 74 with which the pin 73 of the day/night indicating pipe collaborates in the two stable angular positions thereof. It is also possible to see that two grooves 109 in the form of arcs of a circle can be formed on each side of the two blind holes, to make it easier for the day/night-indicting pipe to turn by reducing the compression of the helical spring 71.

The foregoing description corresponds to a preferred embodiment of the invention described without implying any limitation. In particular, the shapes depicted and described for the various constituent parts of the timepiece movement are nonlimiting.

The present invention is not restricted to displaying two additional items of information with the same hand or to the use of an hours hand to do so. For example, it is possible to anticipate using the display according to the present invention in conjunction with a date hand which, as it rotates on itself, would also be able to display leap years in steps of one quarter of a revolution, or months, in steps of one twelfth of a revolution.

It is also possible to use the two additional information display mechanisms as described, but independently. Conversely, if the constraints imposed upon the watchmaker in terms of bulk so permit, the watchmaker may anticipate displaying more than two additional items of information using the same hand, without departing from the scope of the present invention. Alternatively, it is also possible to anticipate two hands, particularly the hours hand and the minutes hand, behaving similarly, for example simultaneously displaying the day/night information using similar mechanisms.

To complement the foregoing, it will also be noted that it is possible to add, to the movement described, a mechanism for determining the times of sunrise and sunset, for example, from which mechanism the control wheel 95 would be driven so that the times at which the day/night information changed could alter over the course of a year.

Furthermore, displaying the magnitude of the power reserve has been explained by way of illustration also. It is of course conceivable to display other information, particularly in a timepiece of electromechanical type. When the invention is implemented in a timepiece of mechanical type, the number of barrels is nonlimiting also, as is the use of differential gearing.

1-17. (canceled)

18. A hand for a timepiece comprising a base, intended to be driven by a drive member of a clock movement to rotate about a first axis of rotation, said base being extended by a first index portion intended to collaborate with graduations of the timepiece,
wherein said first index portion defines a support for a second index portion equipped with a spur or bevel toothing, with reference to a second axis of rotation substantially perpendicular to said first axis of rotation, and intended to be driven in terms of rotation with respect to said support, about the said second axis of rotation, by a drive mobile of said clock movement.

19. The hand as claimed in claim 18, wherein said base comprises a pipe the axis of which is coincident with said first axis of rotation, said first index portion being defined by a shaft extending substantially perpendicular to said pipe from said base.

20. The hand as claimed in claim 18, wherein said first portion bears a retaining element, some distance from said base, defining an axial banking for said second index portion, said axial banking also performing a function of angularly positioning said second index portion with respect to said base.

21. The hand as claimed in claim 19, wherein said first portion bears a retaining element, some distance from said base, defining an axial banking for said second index portion, said axial banking also performing a function of angularly positioning said second index portion with respect to said base.

22. The hand as claimed in claim 18, wherein it comprises elastic means designed in such a way as to exert a force on said second index portion that tends to keep it against said axial banking while at the same time allowing it to move away from said axial banking in order to rotate on itself.

23. The hand as claimed in claim 18, wherein said second index portion has graduations relating to the value of a parameter associated with said clock movement or relating to a time parameter.

24. The hand as claimed in claim 18, wherein said second index portion has at least one mobile window positioned in such a way as to move in order to reveal or conceal a visual marking representative of the angular position thereof with respect to said base.

25. The hand as claimed in claim 18, wherein it comprises a third index portion coaxial with said first and second portions and arranged between these, this portion being intended to be driven in terms of rotation with respect to said support by said clock movement about said second axis of rotation and independently of said second index portion.

26. The hand as claimed in claim 25, wherein said third index portion also has a spur or bevel toothing with reference to said second axis of rotation and is intended to collaborate with an additional driving toothing of said clock movement.

27. A clock movement comprising a going train kinematically connected to drive means for rotationally driving at least a base of a hand about a first axis of rotation substantially perpendicular to an overall plane of the movement, said base being secured to a first index portion intended to collaborate with graduations of the timepiece,
wherein it further comprises at least one additional drive mobile designed to drive a second index portion of said hand, this second portion being supported by said first index portion, in terms of rotation about a second axis of rotation substantially perpendicular to said first axis of rotation.

28. The clock movement as claimed in claim 27, wherein said additional drive mobile has a spur or bevel toothing designed to be placed in mesh with a spur or bevel toothing of said second index portion.

29. The clock movement as claimed in claim 28, wherein said additional drive mobile is designed in such a way that it periodically drives said second index portion so that it makes half a revolution on itself in order to exhibit a first or a second distinct angular position.

30. The clock movement as claimed in claim 29, wherein it comprises a whip mechanism actuated to control the movements of said additional drive mobile.

31. The clock movement as claimed in claim 28, comprising a source of energy that has a predefined power reserve, wherein said additional drive mobile is controlled in such a way as to associate the angular position of said second index portion with the magnitude of said power reserve at each moment.

32. The clock movement as claimed in claim 31, further comprising a winding mechanism connected to an input of said source of energy, said source also comprising an output connected to said going train, the movement further comprising differential gearing having a first input kinematically connected to said input of said source of energy, a second input kinematically connected to said output of said source of energy and an output kinematically connected to said additional drive mobile.

33. The clock movement as claimed in claim 32, wherein it comprises a first and a second gear-train, these two gear-trains being arranged, respectively, between said input of said source of energy and said first input of said differential gearing and between said output of said source of energy and said second input of said differential gearing, said first and second gear-trains having different respective gear ratios.

34. The clock movement as claimed in claim 27, wherein it comprises additional drive means designed to allow the rotational driving of a third index portion of said hand which is coaxial with said first and second index portions, about said second axis of rotation.

35. A timepiece comprising a case closed by a glass and defining a housing in which there is positioned a clock movement designed to drive a hand moving between said movement and said glass, said hand comprising a base, intended to be driven by drive means of a clock movement to rotate about a first axis of rotation substantially perpendicular to an overall plane of the movement, said base being extended by a first index portion intended to collaborate with graduations of the timepiece,
wherein said first index portion defines a support for a second index portion equipped with a spur or bevel toothing, with reference to a second axis of rotation substantially perpendicular to said first axis of rotation, and intended to be driven in terms of rotation with respect to said support, about the said second axis of rotation, by a drive mobile of said clock movement.
